(19) United States
(12) Patent Application Publication
(10) Pub. No.: US 2026/0282172 A1
(43) Pub. Date: Sep. 17, 2026

(54) SHEET HEATING ELEMENT AND METHOD OF MANUFACTURING THE SAME

(71) Applicant: NURI VISTA CO., LTD., Seoul (KR)

(72) Inventors: Yong Hwan GU, Incheon (KR); Seong Sil PARK, Incheon (KR); Chang Ho CHOI, Goesan-gun, Chungcheongbuk-do (KR)

(73) Assignee: NURI VISTA CO., LTD., Seoul (KR)

(21) Appl. No.: 18/872,158

(22) PCT Filed: Jun. 7, 2023
(86) PCT No.: PCT/KR2022/007990

§ 371 Date: Dec. 5, 2024

(51) Int. Cl. H05B 3/20; H05B 3/03

(52) U.S. Cl. CPC H05B 3/20; H05B 3/03

(57) ABSTRACT

A sheet heating element includes a base film, a heating layer formed on a first surface of the base film, a pair of electrodes disposed on the first surface of the base film with the heating layer therebetween and configured to supply power to the beating layer, and a silicone insulating layer provided to cover the heating layer and the electrodes, wherein the silicone insulating layer is integrally formed with the heating layer through a spray coating process or casting process. Therefore, the sheet heating element may have excellent heat resistance and dielectric strength characteristics.

### CROSS-REFERENCE TO RELATED APPLICATIONS

The present application is a National Stage Application of PCT International Application No.: PCT/KR2022/007990 filed on Jun. 7, 2023, the disclosure of which is incorporated herein by reference in its entirety.

### TECHNICAL FIELD

Embodiments of the present disclosure relates to a sheet heating element and method of manufacturing the same. More specifically, embodiments of the present disclosure relate to a sheet heating element including a heating layer having carbon components and an insulating layer formed to cover the heating layer, and a method of manufacturing the sheet heating element.

### BACKGROUND

Sheet heating elements are widely used in mats, pads, bed mattresses, and residential heating devices for general housing due to their ease of temperature control and noiseless operation.

A sheet heating element includes a base film, a heating layer, and an insulating layer provided to cover the heating layer. A pair of electrodes is provided on the base film to allow the heating layer to generate heat primarily using electricity. By applying electricity to the electrodes, the heating layer can generate heat. The insulating layer electrically insulates the heating layer while protecting the heating layer from moisture or water.

The insulating layer may be typically attached to the base film by laminating an insulating polymer film onto the heating layer.

Among insulating polymers, polyimide (hereinafter, referred to as ‘PI’) is a very suitable material for use as an insulating layer due to its excellent heat resistance. In this case, silicone adhesive is very suitable in terms of heat resistance, electrical insulation, and adhesion force when laminating the PI film onto the heating layer.

However, silicone adhesive and PI film have different shrinkage/expansion rates depending on temperature changes. Therefore, when laminating PI film using silicone adhesive, the silicone adhesive may easily delaminate the PI film from the heating layer. In particular, the silicone adhesive thermally decomposes at temperatures above 200° C., resulting in the destruction of electrically insulation characteristics at high temperatures.

Meanwhile, the insulating layer usable at temperatures above 200° C. contain thermosetting materials, such that the insulating layer may have problems of relatively low flexibility and deteriorated dielectric strength.

### SUMMARY

The embodiment of the present invention provides a sheet heating element including an insulating layer of improved heat resistance and dielectric strength.

Embodiments of the present invention also provide a method of manufacturing a sheet heating element having an insulating layer of improved heat resistance and dielectric strength.

According to some embodiments of the present invention, a sheet heating element includes a base film, a heating layer formed on a first surface of the base film, a pair of electrodes disposed on the first surface of the base film with the heating layer therebetween and configured to supply power to the heating layer, and a silicone or urethane insulating layer provided on the base film to cover the heating layer and the electrodes, wherein the silicone or urethane insulating layer is integrally formed with the heating layer through a spray coating or casting process.

In an example embodiment, a heat isolation layer may be further formed on a second surface of the base film.

Here, the heat isolation layer comprises a micro-porous foam layer therein.

According to some embodiments of the present invention, a method of manufacturing a sheet heating element is provided. The method includes forming a heating layer on a first surface of a base film using a conductive paste, forming a pair of electrodes on a first surface of the base film with the heating layer therebetween, the electrodes being configured to supply power to the heating layer, and forming a silicone insulating layer to cover the heating layer and the electrodes, wherein the silicone insulating layer is integrally formed with the heating layer through a spray coating process.

In an example embodiment, forming the heating layer may be performed by any one method selected from the group consisting of screen printing, offset printing, gravure printing, flexo printing, letterpress printing, inkjet printing, and roll-to-roll gravure printing.

In an example embodiment, the base film may be formed using any one material selected from the group consisting of polyethylene terephthalate (PET), polyimide (PI), polycarbonate (PC), polyethersulfone (PES), polyarylate (PAR), cyclo olefin (COC), and combinations thereof.

In an example embodiment, a heat isolation layer may be further formed on the second surface of the base film.

Here, the heat isolation layer may be formed through the spray coating process.

According to some embodiments of the present invention, the sheet heating element includes the silicone insulating layer that covers the heating layer and electrodes and is integrally formed with the heating layer through a spray coating process. As a result, the sheet heating element can secure improve heat resistance and insulation properties.

Furthermore, the sheet heating element including the micro-porous foam layer can control the heating direction by preventing heat from passing through the second surface with the micro-porous foam layer and allowing selective heating direction where the heat passes through the silicone insulating layer via the first surface.

The above summary of the present disclosure is not intended to describe each illustrated embodiment or every implementation of the present disclosure. The detailed description and claims that follow more particularly exemplify these embodiments.

### BRIEF DESCRIPTION OF THE DRAWINGS

Embodiments can be understood in more detail from the following description taken in conjunction with the accompanying drawings, in which:

FIG. 1 is a cross-sectional view illustrating a sheet heating element according to some embodiments of the present invention; and

FIG. 2 is a flowchart illustrating a method of manufacturing a sheet heating element according to some embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Hereinafter, embodiments of the present invention are described in more detail with reference to the accompanying drawings. However, the present invention is not limited to the embodiments described below and is implemented in various other forms. Embodiments below are not provided to fully complete the present invention but rather are provided to fully convey the range of the present invention to those skilled in the art.

In the specification, when one component is referred to as being on or connected to another component or layer, it can be directly on or connected to the other component or layer, or an intervening component or layer may also be present. Unlike this, it will be understood that when one component is referred to as directly being on or directly connected to another component or layer, it means that no intervening component is present. Also, though terms like a first, a second, and a third are used to describe various regions and layers in various embodiments of the present invention, the regions and the layers are not limited to these terms.

Terminologies used below are used to merely describe specific embodiments, but do not limit the present invention. Additionally, unless otherwise defined here, all the terms including technical or scientific terms, may have the same meaning that is generally understood by those skilled in the art.

Embodiments of the present invention are described with reference to schematic drawings of ideal embodiments. Accordingly, changes in manufacturing methods and/or allowable errors may be expected from the forms of the drawings. Accordingly, embodiments of the present invention are not described being limited to the specific forms or areas in the drawings, and include the deviations of the forms. The areas may be entirely schematic, and their forms may not describe or depict accurate forms or structures in any given area, and are not intended to limit the scope of the present invention.

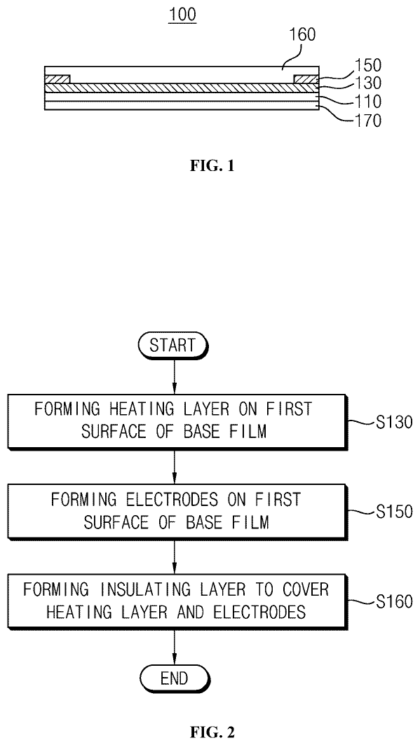

FIG. 1 is a cross-sectional view illustrating a sheet heating element according to some embodiments of the present invention.

Referring to FIG. 1, a sheet heating element 100 according to some embodiments of the present invention includes a base film 110, a heating layer 130, a pair of electrodes 150, and a silicone insulating layer 160.

The base film 110 may include an insulating film for flexibility. For example, the base film 110 includes at least one material selected from polyethylene terephthalate (PET), polyimide (PI), polycarbonate (PC), polyethersulfone (PES), polyarylate (PAR), and cyclo olefin (COC).

The heating layer 130 is formed on a first surface of the base film 110. The heating layer 130 can perform heating functions when power is supplied. The heating layer 130 may be formed using a conductive paste.

The conductive paste may include conductive particles, a surfactant, and a solvent.

The conductive particles may be made of carbon nanotubes, graphene, copper, nickel, gold, silver, platinum, palladium, tin, aluminum, indium oxide, zinc oxide, tin oxide, or combinations thereof. For example, the conductive particles are preferably carbon nanotubes, and the carbon nanotubes may be selected from single-wall carbon nanotubes, double-wall carbon nanotubes, multi-wall carbon nanotubes, and combinations thereof, preferably single-wall carbon nanotubes.

According to one embodiment, the conductive paste may be formed by mixing and pastefying a solution in which 5 to 15 parts by weight of carbon conductive particles such as graphene and carbon nanotubes and 1 to 10 parts by weight of surfactant are dispersed.

If the carbon conductive particles are less than 5 parts by weight, the conductivity is low and the heat generation is insufficient, and if they exceed 15 parts by weight, the dispersibility becomes poor, causing the resistance of the heating layer to become non-uniform, thereby degrading the quality of the sheet heating element.

Meanwhile, if the surfactant is less than 1 part by weight, the dispersibility becomes poor, causing the resistance of the heating layer to become non-uniform, and if it exceeds 10 parts by weight, the relative content of carbon nanotubes decreases, lowering the conductivity and making the heat generation insufficient.

Specially, the surfactant prevents agglomeration of carbon nanotubes and improves dispersibility.

The surfactant may be one or more selected from the group consisting of cationic surfactants, anionic surfactants, non-ionic surfactants, and amphoteric surfactants.

The solvent may include alpha-terpineol, N-methylpyrrolidone, butyl cellosolve, butyl cellosolve acetate, ethyl cellosolve, ethyl cellosolve acetate, ethyl carbitol, ethyl carbitol acetate, butyl carbitol, butyl carbitol acetate, ethoxyethyl acetate, butyl acetate, propylene glycol monomethyl ether, propylene glycol monomethyl ether acetate, γ-butyrolactone, methyl ethyl ketone, and mixtures thereof.

The conductive paste may be formed through mixing and milling processes after dispersing the carbon conductive particles and surfactant in the solvent.

The heating layer 130 may be formed on the base film through a printing process. The printing process may include any one of screen printing, offset printing, gravure printing, flexo printing, letterpress printing, inkjet printing, and roll-to-roll gravure printing.

The pair of electrodes 150 is disposed on the first surface of the base film 110 with the heating layer 130 therebetween. The pair of electrodes 150 is electrically connected to the heating layer 130. Thus, the pair of electrodes 150 can supply power to the heating layer 130.

The conductive material forming the pair of electrodes 150 includes, for example, metal materials such as silver, zinc, aluminum, copper, etc.

The silicone insulating layer 160 is provided on the base film to cover the heating layer 130 and the electrodes 150. Thus, the silicone insulating layer 160 may electrically insulate the heating layer 130 and the electrodes 150 from the outside.

The silicone insulating layer 160 may have a thickness of 10 to 200 μm. More preferably, the silicone insulating layer 160 may have a thickness of 10 to 100 μm or 10 to 50 μm.

The silicone insulating layer 160 is formed through a spray coating process. Thus, the silicone insulating layer 160 can be integrally formed with the heating layer 130. Therefore, by integrating the silicone insulating layer 160 with the heating layer 130, chemical and physical resistance can be secured.

Specifically, the silicone insulating layer 160 can maintain electrical insulation at high temperatures of at least 300° C. Meanwhile, the silicone insulating layer 160 maintains dielectric strength characteristics under 2 kV AC voltage conditions, thereby having excellent insulation characteristics at AC 220 V operating voltage. Thus, the sheet heating element 100 including the silicone insulating layer 160 can be applied not only to automotive applications but also to industrial, home appliance/office heating elements.

Also, the silicone insulating layer 160 can maintain excellent insulation characteristics even when the heating layer 150 generates heat up to 300° C.

According to one embodiment, a heat isolation layer 170 may be additionally provided on the second surface of the base film 110. The heat isolation layer 170 can suppress heat from radiating toward the second surface of the base film 110. Thus, the sheet heating element 100 can limit the heating direction so that heat generated from the heating layer 130 passes through the silicone insulating layer 160 via the first surface of the base film 110, excluding the second surface.

Here, the heat isolation layer 170 may include a micro-porous foam layer.

The micro-porous foam layer may include a material containing thermoplastic microspheres that encapsulate air, for example, Expancel™ (manufactured by Nouryon Chemicals International B.V.).

The micro-porous foam layer can secure excellent heat blocking effect, i.e., insulation effect, by including microspheres that encapsulate air internally.

Therefore, the sheet heating element 100 including the micro-porous foam layer can block heat passing through the second surface with the micro-porous foam layer and allow selective heating through the silicone insulating layer 160 via the first surface.

FIG. 2 is a flowchart illustrating a method of manufacturing a sheet heating element according to some embodiment of the present invention.

Referring to FIGS. 1 and 2, Referring to FIGS. 1 and 2, in a method of manufacturing a sheet heating element according to an embodiment of the present invention, a heating layer 130 is formed on a first surface of a base film 110 using a conductive paste (S130).

The conductive paste may include conductive particles, a surfactant, and a solvent.

The conductive particles may be composed of carbon nanotubes, graphene, copper, nickel, gold, silver, platinum, palladium, tin, aluminum, indium oxide, zinc oxide, tin oxide, and combinations thereof. For example, the conductive particles are preferably carbon nanotubes, and the carbon nanotubes may be selected from the group consisting of single-wall carbon nanotubes, double-wall carbon nanotubes, multi-wall carbon nanotubes, and combinations thereof, preferably single-wall carbon nanotubes.

In one embodiment of the present invention, the conductive paste may be formed by mixing and converting into a paste a solution in which 5 to 15 weight percentage of carbon conductive particles such as graphene and carbon nanotubes and 1 to 10 weight percentage of surfactant are dispersed.

If the carbon conductive particles are less than 5 weight percentage, the conductivity is low and the heat generation is insufficient, and if they exceed 15 weight percentage, the dispersibility becomes poor, causing the resistance of the heating part to become non-uniform, thereby potentially degrading the quality of the sheet heating element.

Meanwhile, if the surfactant is less than 1 weight percentage, the dispersibility becomes poor, causing the resistance of the heating part to become non-uniform, and if it exceeds 10 weight percentage, the relative content of carbon nanotubes decreases, lowering the conductivity and making the heat generation insufficient.

Meanwhile, the surfactant prevents the agglomeration phenomenon of carbon nanotubes and improves dispersibility.

The surfactant may be one or more selected from the group consisting of cationic surfactants, anionic surfactants, non-ionic surfactants, and amphoteric surfactants.

The solvent may include alpha-terpineol, N-methylpyrrolidone, butyl cellosolve, butyl cellosolve acetate, ethyl cellosolve, ethyl cellosolve acetate, ethyl carbitol, ethyl carbitol acetate, butyl carbitol, butyl carbitol acetate, ethoxyethyl acetate, butyl acetate, propylene glycol monomethyl ether, propylene glycol monomethyl ether acetate, γ-butyrolactone, methyl ethyl ketone, and mixtures thereof.

The conductive paste may be formed through mixing and milling processes after dispersing the carbon conductive particles and surfactant in the solvent.

The heating layer 130 may be formed on the base film through a printing process. The printing process may include any one of screen printing, offset printing, gravure printing, flexo printing, letterpress printing, inkjet printing, and roll-to-roll gravure printing.

Next, a pair of electrodes 150 configured to supply power to the heating layer 130 is formed on the first surface of the base film 110 with the heating layer 130 therebetween (S150).

The pair of electrodes 150 may be formed through a printing process.

Next, a silicone insulating layer 160 integrally formed with the heating layer is formed through a spray coating process to cover the heating layer 130 and the electrodes 150.

Thus, the silicone insulating layer 160 can be integrally formed with the heating layer 150 (S160). Therefore, by integrating the silicone insulating layer 160 with the heating layer 150, chemical and physical resistance can be secured.

Specifically, the silicone insulating layer 160 can maintain electrical insulation at high temperatures of at least 300° C. Meanwhile, the silicone insulating layer 160 maintains dielectric strength characteristics under 2 kV AC voltage conditions, thereby having excellent insulation characteristics at AC 220 V operating voltage.

In one embodiment of the present invention, a heat isolation layer 170 may be additionally formed on the second surface of the base film. Here, the heat isolation layer 170 may be formed through the spray coating process.

Referring to FIGS. 1 and 2, a method of manufacturing a sheet heating element in accordance with some embodiments of the present invention, a heating layer 130 is formed on a first surface of a base film 110 using a conductive paste (S130).

The conductive paste may include conductive particles, a surfactant, and a solvent.

The conductive particles may include carbon nanotubes, graphene, copper, nickel, gold, silver, platinum, palladium, tin, aluminum, indium oxide, zinc oxide, tin oxide, and combinations thereof. For example, the conductive particles are preferably carbon nanotubes, and the carbon nanotubes may be selected from the group consisting of single-wall carbon nanotubes, double-wall carbon nanotubes, multi-wall carbon nanotubes, and combinations thereof, preferably single-wall carbon nanotubes.

In one embodiment of the present invention, the conductive paste may be formed by mixing and converting into a paste a solution in which 5 to 15 weight percentage of carbon conductive particles such as graphene and carbon nanotubes and 1 to 10 weight percentage of surfactant are dispersed.

If the carbon conductive particles are less than 5 weight percentage, the conductivity is low and the heat generation is insufficient, and if they exceed 15 weight percentage, the dispersibility becomes poor, causing the resistance of the heating part to become non-uniform, thereby potentially degrading the quality of the sheet heating element.

Meanwhile, if the surfactant is less than 1 weight percentage, the dispersibility becomes poor, causing the resistance of the heating part to become non-uniform, whereas if it exceeds 10 weight percentage, the relative content of carbon nanotubes decreases, lowering the conductivity and making the heat generation insufficient.

Meanwhile, the surfactant prevents the agglomeration phenomenon of carbon nanotubes and improves dispersibility.

The surfactant may be one or more selected from the group consisting of cationic surfactants, anionic surfactants, non-ionic surfactants, and amphoteric surfactants.

The solvent may include alpha-terpineol, N-methylpyrrolidone, butyl cellosolve, butyl cellosolve acetate, ethyl cellosolve, ethyl cellosolve acetate, ethyl carbitol, ethyl carbitol acetate, butyl carbitol, butyl carbitol acetate, ethoxyethyl acetate, butyl acetate, propylene glycol monomethyl ether, propylene glycol monomethyl ether acetate, γ-butyrolactone, methyl ethyl ketone, and mixtures thereof.

The conductive paste may be formed through mixing and milling processes after dispersing the carbon conductive particles and surfactant in the solvent.

The heating layer 130 may be formed on the base film through a printing process. The printing process may include any one of screen printing, offset printing, gravure printing, flexo printing, letterpress printing, inkjet printing, and roll-to-roll gravure printing.

Next, a pair of electrodes 150 configured to supply power to the heating layer 130 is formed on the first surface of the base film 110 with the heating layer 130 therebetween (S150).

The pair of electrodes 150 may be formed through a printing process.

Next, a silicone insulating layer 160 integrally formed with the heating layer 130 is formed through a spray coating process to cover the heating layer 130 and the electrodes 150.

Thus, the silicone insulating layer 160 can be integrally formed with the heating layer 150 (S160). Therefore, by integrating the silicone insulating layer 160 with the heating layer 130, chemical and physical resistance can be secured.

Specifically, the silicone insulating layer 160 can maintain electrical insulation at high temperatures of at least 300° C. Meanwhile, the silicone insulating layer 160 maintains dielectric strength characteristics under 2 kV AC voltage conditions, thereby having excellent insulation characteristics at AC 220 V operating voltage.

In one embodiment of the present invention, a heat isolation layer 170 may be additionally formed on the second surface of the base film. Here, the heat isolation layer 170 may be formed through the spray coating process.

Although the example embodiments of the present disclosure have been described with reference to the specific embodiments, they are not limited thereto. Therefore, it will be readily understood by those skilled in the art that various modifications and changes can be made thereto without departing from the spirit and scope of the present disclosure defined by the appended claims.

1. A sheet heating element comprising:
a base film;
a heating layer formed on a first surface of the base film;
a pair of electrodes disposed on the first surface of the base film with the heating layer therebetween and configured to supply power to the heating layer; and
a silicone or urethane insulating layer provided to cover the heating layer and the pair of electrodes, wherein the silicone or urethane insulating layer is integrally formed with the heating layer through a spray coating or casting process.

2. The sheet heating element of claim 1, further comprising a heat isolation layer formed on a second surface of the base film.

3. The sheet heating element of claim 2, wherein the heat isolation layer comprises a micro-porous foam layer.

4. A method of manufacturing a sheet heating element, the method comprising:
forming a heating layer on a first surface of a base film using a conductive paste;
forming a pair of electrodes on the first surface of the base film with the heating layer therebetween, the pair of electrodes being configured to supply power to the heating layer; and
forming a silicone insulating layer to cover the heating layer and the pair of electrodes, wherein the silicone insulating layer is integrally formed with the heating layer through a spray coating process.

5. The method of claim 4, wherein forming the heating layer is performed by any one method selected from the group consisting of screen printing, offset printing, gravure printing, flexo printing, letterpress printing, inkjet printing, and roll-to-roll gravure printing.

6. The method of claim 4, wherein the base film is formed using any one material selected from the group consisting of polyethylene terephthalate (PET), polyimide (PI), polycarbonate (PC), polyethersulfone (PES), polyarylate (PAR), cyclo olefin (COC), and combinations thereof.

7. The method of claim 4, further comprising forming a heat isolation layer on the second surface of the base film.

8. The method of claim 7, wherein the heat isolation layer is formed through the spray coating process.
